(19) United States
(12) Patent Application Publication
(10) Pub. No.: US 2024/0424961 A1
(43) Pub. Date: Dec. 26, 2024

(54) VEHICLE SEAT WITH AN EMERGENCY-EVACUATION CONNECTING ROD

(71) Applicant: FAURECIA Sièges d'Automobile, Nanterre (FR)

(72) Inventors: Sylvain ROCHE, VARENNES CHANGY (FR); David EPAUD, LARDY (FR); Farouk BOUZID, BRETIGNY SURORGE (FR)

(21) Appl. No.: 18/703,064

(22) PCT Filed: Oct. 14, 2022
(86) PCT No.: PCT/FR2022/051941

§ 371 Date: Apr. 19, 2024

(30) Foreign Application Priority Data
Oct. 28, 2021 (FR) FR2111455

(51) Int. Cl. B60N 2/30

(52) U.S. Cl. CPC B60N 2/3011; B60N 2/3065; B60N 2/309

(57) ABSTRACT

The present disclosure relates to a vehicle seat (1) comprising:—a seat frame (2),—anchoring means (3) for anchoring the seat (1) to the floor of a vehicle,—connecting means (4) for connecting the seat frame (2) to the anchoring means (3), allowing the seat frame (2) to be moved with respect to the anchoring means (3) at least in the longitudinal direction (X) and in the vertical direction (Z) of the seat (1),—a backrest (5) pivotably articulated to the seat frame (2) in the vicinity of its rear edge (AR) about a first transverse axis (Y1) of the seat (1),—an underframe (6) pivotably articulated to the anchoring means (3) about a second transverse axis (Y2) of the seat (1) and pivotably articulated to the backrest (5) about a third transverse axis (Y3) of the seat (1). The underframe (6) is articulated to the anchoring means (3) by way of an emergency connecting rod (10) that allows the seat to be tilted into an exit-facilitating emergency position.

The invention relates to a seat for a vehicle, and in particular of a motor vehicle, as well as a vehicle equipped with such a seat.

### TECHNICAL FIELD

In well-known manner, a vehicle generally comprises at least one seat intended to accommodate a driver or a passenger of the vehicle, hereinafter referred to as a “user”. The term “user” may also refer to another occupant of the vehicle receiving the seat, and in particular an occupant located near said seat. The seat may be intended to accommodate a single person or multiple seated people side by side, and can be arranged at the front or rear of the vehicle.

Thus, within the meaning of the invention, the term “seat” according to the invention refers to both a front seat of the vehicle and a rear seat of the vehicle. Likewise, the invention can be implemented for seats intended for any type of vehicle and in particular for motor vehicles.

A vehicle seat generally comprises a seat frame, configured to be connected to the floor of a vehicle, in particular by anchoring means for anchoring to the floor of the vehicle, generally comprising two slides, arranged on either side of the seat frame in the transverse direction of the seat and configured to be attached to the floor of the vehicle while allowing the seat to slide relative to the floor of the vehicle in the longitudinal direction of the seat.

Also in a known manner, the seat frame has a front edge and a rear edge connected to each other by a first lateral edge and a second lateral edge, the seat frame being configured so as to accommodate at least one user.

The seat frame can be connected to the anchoring means by connecting means enabling the movement of the seat frame relative to the anchoring means at least in the longitudinal direction and in the vertical direction of the seat, and therefore relative to the floor of the vehicle, so as to be able to adopt different positions relative to the floor of the vehicle making it possible to offer the seat different configurations of use.

The seat may also comprise at least one backrest, articulated pivotably

along a first transverse axis of the seat to the seat frame, at the rear edge thereof, as well as an underframe articulated to the anchoring means along a second transverse axis of the seat and to the backrest along a third transverse axis of the seat, so that the movement of the seat frame relative to the anchoring means in the longitudinal direction and in the vertical direction of the seat, and therefore relative to the floor of the vehicle, causes the simultaneous pivoting of the backrest relative to the seat frame around said first transverse axis, and also in order to offer different configurations of use.

Said connecting means for connecting the seat frame to the anchoring means may in particular comprise a front connecting rod, having a first longitudinal end and a second longitudinal end, articulated to the means for anchoring to the floor of the vehicle near its first longitudinal end around a fourth transverse axis of the seat and to the seat frame near its second longitudinal end around a fifth transverse axis of the seat.

Said various configurations of the seat correspond in particular to the various positions that can be envisaged of the backrest relative to the seat frame, combined with the various positions that can be envisaged of the seat frame relative to the anchoring means.

For example, when a user is seated on the vehicle seat, in particular during a journey of the vehicle, said seat can be provided in order to be in a so-called “nominal” configuration, wherein the seat frame is substantially parallel to the floor of the vehicle, while the backrest extends substantially in the vertical direction of the vehicle, corresponding substantially to the vertical direction of the seat when the vehicle seat is attached to the floor of the vehicle, and substantially perpendicular to the floor of the vehicle.

In order to clear the passage at the rear of the seat, for example to allow users to enter or exit the vehicle receiving the seat, by moving to the rear of said seat, in particular when it is a vehicle without rear doors, a so-called “easy entry” configuration can be provided, wherein, the rear edge of the seat frame and the underframe are displaced upward, in the vertical direction of the seat, and forward, in the longitudinal direction of the seat, relative to their position in said “nominal” configuration. In such a configuration, the front edge of the seat frame can be provided to move forward, in the longitudinal direction of the seat, while approaching the anchoring means, in the vertical direction of the seat, via the pivoting of said front connecting rod around the fourth and the fifth transverse axis of the seat, as described above. Likewise, the articulation of the underframe to the backrest along the third transverse axis of the seat can also be moved upward, along the direction, in the vertical direction of the seat, and forward, in the longitudinal direction of the seat, via the pivoting of the underframe relative to the anchoring means about said second transverse axis as described above.

To facilitate the movement of the seat frame relative to the anchoring means in order to switch the seat from its “nominal” configuration to its “easy entry” configuration, and vice versa, it is known to use an actuator, and in particular an electric motor, driving the rotation of the front connecting rod relative to the anchoring means around the fourth transverse axis of the seat.

Provision may also be made for a so-called “flat floor” configuration, wherein the backrest is folded back against the seat frame, extending substantially parallel thereto and wherein also, the seat frame is moved forward in the longitudinal direction of the seat and downwards in the vertical direction of the seat relative to its position in said “nominal” configuration. Such a “flat floor” configuration advantageously makes it possible to reduce the form factor of the seat in its vertical direction, and for example in order to be able to deposit one or more loads onto the folded backrest, in particular when said seat is located behind a vehicle just in front of a rear loading compartment of the vehicle, in the longitudinal direction of the vehicle.

To facilitate the movement of the seat frame relative to the anchoring means in order to switch the seat from its “nominal” configuration to its “flat floor” configuration, and vice versa, it is known to use an actuator, and in particular an electric motor, driving the rotation of the front connecting rod relative to the anchoring means around the fourth transverse axis of the seat.

Advantageously, the same single actuator, and in particular the same single electric motor, can be provided to drive the pivoting of the front connecting rod relative to the anchoring means around said fourth transverse axis to allow the seat to switch from its “nominal” configuration to its “easy entry” configuration and vice versa, and to switch from its “nominal” configuration to its “flat floor” configuration and vice versa.

This makes it possible to use a single actuator, and in particular a single electric motor, to drive the movement of the seat frame relative to the anchoring means and that of the backrest relative to the seat frame, and therefore to drive the switching of the seat from its “nominal” configuration to its “easy entry” configuration and vice versa, but also from its “nominal” configuration to its “flat floor” configuration and vice versa.

In order to allow such an operation of the seat, a first locking means can in particular be provided, able to switch from a locked state, wherein said first locking means prevents the rotation of the underframe relative to the anchoring means around said second transverse axis of the seat, to an unlocked state, wherein said first locking means allows the rotation of the underframe relative to the anchoring means about said second transverse axis of the seat, and vice versa.

A second locking means can also be provided, able to switch from a locked state, wherein said second locking means prevents the rotation of the backrest relative to the underframe around said third transverse axis, to an unlocked state, wherein said second locking means allows the rotation of the backrest relative to the underframe around said third transverse axis.

The first locking means and/or the second locking means may advantageously be provided to be controlled electronically to switch from their locked state to their unlocked state and vice versa.

Thus, during the switching of the seat from its “nominal” configuration to its “easy entry” configuration and vice versa, said first locking means is in its unlocked state, while the second locking means is in its locked state. Likewise, during the switching of the seat from its “nominal” configuration to its “flat floor” configuration, and vice versa, said first locking means is in its locked state, while the second locking means is in its unlocked state.

It may also be desirable to be able to move the seat frame and the underframe relative to the means for anchoring to the floor of the vehicle by separating the rear edge of the seat frame and the underframe from the anchoring means for anchoring to the floor of the vehicle in the vertical direction of the seat in order to give the seat a so-called “panic exit” configuration, so as to clear the passage at the rear of said seat in the longitudinal direction of the seat, manually, i.e. without the aid of the actuator, and in particular of the electric motor, rotating said connecting rod connected to the front edge of the seat frame relative to the anchoring means around said fourth transverse axis of the seat, in particular in the event of a crash of the vehicle requiring its occupants to exit rapidly, and in particular the occupants located at the rear of said seat in the longitudinal direction of the seat, or if said actuator has been disabled or damaged.

To this end, it is known that said actuator is a reversible electric motor, i.e. configured to allow the rotation of its rotor, respectively of its stator, relative to its stator, respectively its rotor, when it is not enabled, in order to allow the manual movement of the seat frame relative to the anchoring means for anchoring to the floor of the vehicle or the manual pivoting of the backrest relative to the seat frame around said first transverse axis of the seat.

However, this design has drawbacks.

In particular, reversible electric motors generally deliver a motor torque that is reduced relative to the irreversible electric motors, and generally by a factor of 2. For example, reversible electric motors used for vehicle seats generally provide a motor torque of about 25 Nm, while an irreversible motor having a substantially equivalent bulk and power can generally provide a motor torque at least equal to 50 Nm. Thus, the use of a reversible electric motor can complicate the design of the seat according to the invention, in that its elements must, for example, be lightened to allow the movement of the seat frame and the underframe relative to the anchoring means for anchoring to the floor of the vehicle and the pivoting of the backrest relative to the seat frame and to the underframe respectively about said first transverse axis and said third transverse axis of the seat, and in particular via a front connecting rod and a first locking means and a second locking means as described above, the lever arm between the two ends of such a front connecting rod being generally reduced.

### SUMMARY

The present disclosure improves the situation.

A vehicle seat is proposed, comprising:
a seat frame having a front edge and a rear edge connected to each other by a first lateral edge and a second lateral edge,
anchoring means for anchoring the seat to the floor of a vehicle,
connecting means for connecting the seat frame to the anchoring means, allowing the movement of the seat frame relative to the anchoring means at least in the longitudinal direction and in the vertical direction of the seat,
an articulated backrest pivoting to the seat frame near its rear edge along a first transverse axis of the seat,
an articulated underframe pivoting to the anchoring means along a second transverse axis of the seat and articulated pivoting to the backrest along a third transverse axis of the seat,
   wherein said connecting means comprise:
a front connecting rod having a first longitudinal end and a second longitudinal end, said front connecting rod being pivotably articulated to the anchoring means near its first longitudinal end along a fourth transverse axis of the seat and pivoting articulated to the seat frame near its second longitudinal end along a fifth transverse axis of the seat, near its front edge,
an articulated toothed sector pivoting on the anchoring means along said fourth transverse axis of the seat attached to the first end of the front connecting rod,
   wherein the seat further comprises an electric, irreversible motor configured to:
driving the rotation of the toothed sector relative to the anchoring means about said fourth transverse axis, when enabled, and
preventing the rotation of the toothed sector relative to the anchoring means (3) about said fourth transverse axis, when disabled,
   and wherein the seat further includes:
first locking means able to switch:
   from a locked state, wherein said first locking means prevents the underframe from rotating relative to the seat anchoring means about said second transverse axis, to
   an unlocked state, wherein said first locking means allows a rotation of the underframe relative to the anchoring means about said second transverse axis of the seat, and vice versa,
a second locking means able to switch:
   from a locked state, wherein said second locking means prevents the backrest from rotating relative to the underframe about said third transverse axis, to
   an unlocked state, wherein said second locking means allows the backrest to rotate relative to the underframe about said third transverse axis, and vice versa, and wherein the underframe is articulated to the anchoring means by means of an emergency connecting rod having a first longitudinal end articulated to the anchoring means according to a sixth transverse axis and a second longitudinal end articulated to the underframe with an articulation pin between the emergency connecting rod and the underframe which constitutes the second transverse axis when the emergency connecting rod is in a rest position pressed against the anchoring means, in a position for which the sixth transverse axis is arranged in the longitudinal direction between the second and the third transverse axis,
      and wherein said emergency connecting rod is configured to be in said rest position in the following cases:
when the first locking means is in said locked state, or even
when the front connecting rod is tilted forward by the action of the motor, irreversible, to cause the underframe to pivot about the second transverse axis in the locked state of the second locking means and in the unlocked state of the first locking means,
   and wherein the emergency connecting rod is configured to adopt an emergency position when the first locking means is in the unlocked state, the second locking means being in the locked state and when the front connecting rod is locked in rotation about said fourth transverse axis by the irreversible motor, by pivoting the emergency connecting rod relative to the anchoring means about the sixth transverse axis, and by pivoting the emergency connecting rod relative to the underframe around the articulation pin between the emergency connecting rod and the underframe by allowing the seat frame to tilt forwards around the fifth transverse axis, with the assembly formed by the backrest and the underframe being driven forward in the longitudinal direction and upward in the vertical direction by the articulation formed by the first transverse axis between the backrest and the seat frame to a position where said articulation pin between the emergency connecting rod and the underframe no longer coincides with the second transverse axis, but rather is positioned in the vertical direction between said second transverse axis and the third transverse axis.

The features disclosed in the following paragraphs may optionally be implemented. They may be implemented independently of each other or in combination with each other:
the first locking means may further comprise a first manual control means configured to drive the switching of the first locking means from its locked state to its unlocked state and vice versa by a manual action of a user on said first manual control means;
said first manual control means may comprise a handle pivotably mounted relative to the underframe about a seventh transverse axis of the seat, accessible by a user from the rear of the seat;
the first locking means comprises an actuator, and in particular an electric motor, configured to drive the automatic switching of the first locking means from its locked state to its unlocked state, and vice versa;
the second locking means may comprise an actuator, and in particular an electric motor, configured to drive the automatic switching of the second locking means from its locked state to its unlocked state, and vice versa;
the actuator of the first locking means is the actuator of the second locking means;
the articulation pin between the emergency connecting rod and the underframe may comprise a shaft pivotably connecting the emergency connecting rod and the underframe, said shaft being configured to bear in the rest position of the emergency connecting rod against a recess, integral with the anchoring means, the recess constituting a span for the shaft in said rest position of the emergency connecting rod, and wherein in the emergency position of the emergency connecting rod, the shaft forming the articulation pin between the emergency connecting rod and the underframe is configured to exit and escape from the recess;
the anchoring means may have at least one slide comprising a lower profile rigidly connected to the floor and an upper profile, mounted slidably relative to one another in the longitudinal direction, said upper profile carrying the second transverse axis, the fourth transverse axis and the sixth transverse axis.

According to a second aspect, the present disclosure further relates to a control method wherein a manual control for the emergency evacuation of a user stuck behind a seat according to the present disclosure is then carried out in a nominal position of the seat for which the backrest is raised from the seat frame, with the first locking means in the locked state and the second locking means in the locked state, the emergency connecting rod in the rest position, the emergency evacuation control being implemented by the following steps:
unlocking the first locking means,
manual forward tilting of the seat frame about the fifth transverse axis with the assembly formed by the backrest and the underframe being driven forward in the longitudinal direction and upward in the vertical direction by the articulation formed by the first transverse axis between the backrest and the seat frame when the front connecting rod is rotationally locked about said fourth transverse axis by the irreversible motor by pivoting the emergency connecting rod relative to the means for anchoring around the sixth transverse axis, and pivoting the emergency connecting rod relative to the underframe to a position where said articulation pin between the emergency connecting rod and the underframe no longer coincides with the second transverse axis, but positioned in the vertical direction between said second transverse axis and the third transverse axis.

According to a third aspect, the present disclosure further relates to a control method wherein a motorized control for easy entry facilitating access to the seats behind a seat according to the present disclosure is then carried out in a nominal position of the seat for which the backrest is raised from the seat frame, with the first locking means in the locked state and the second locking means in the locked state, the emergency connecting rod in the rest position, the motorized easy-entry control being implemented by the following steps:
unlocking the first locking means,
motorized forward tilting of the assembly formed by the backrest and the underframe about the second transverse axis by activating the electric motor and rotating the toothed sector relative to the anchoring means about said fourth transverse axis, in a direction of tilting the front connecting rod towards the front of the seat.

According to a fourth aspect, the present disclosure further relates to a control method wherein a motorized flat-floor control of a seat according to the present disclosure is then carried out in a nominal position of the seat for which the backrest is raised from the seat frame, with the first locking means in the locked state and the second locking means in the locked state, the emergency connecting rod in the rest position, the motorized flat-floor control being implemented by the following steps:
unlocking the second locking means,
motorized forward tilting of the backrest against a seat base of the seat about the third transverse axis between the backrest and the underframe by activating the electric motor and rotating the toothed sector relative to the anchoring means about said fourth transverse axis, in a direction of tilting the front connecting rod towards the front of the seat.

### BRIEF DESCRIPTION OF THE DRAWINGS

Other features, details and advantages will appear on reading the detailed description below, and on analyzing the appended drawings, in which:

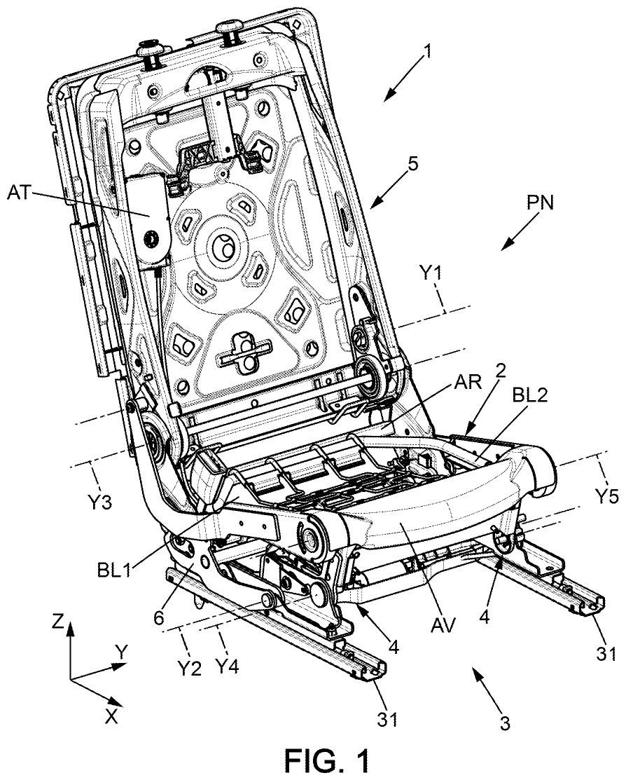

### FIG. 1

FIG. 1 is a perspective view of a seat according to the present disclosure in a nominal position for which the first locking means and the second locking means are in the locked state, the emergency connecting rod in the rest position.

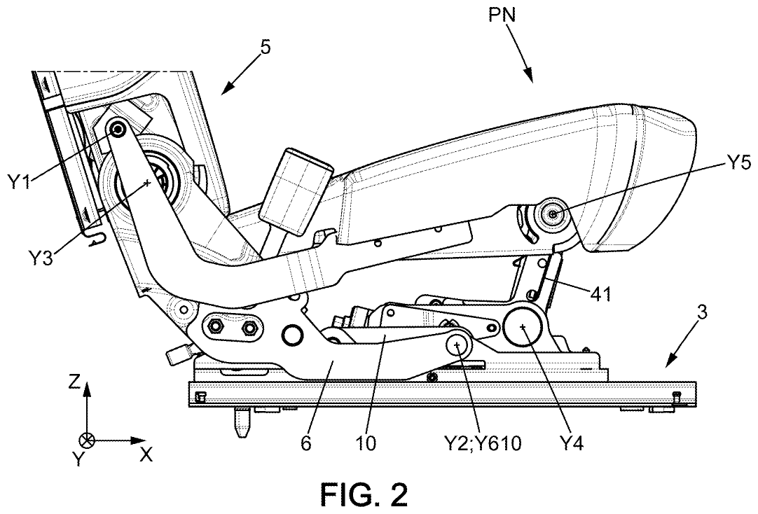

### FIG. 2

FIG. 2 is a detail view of the underframe of the seat of FIG. 1.

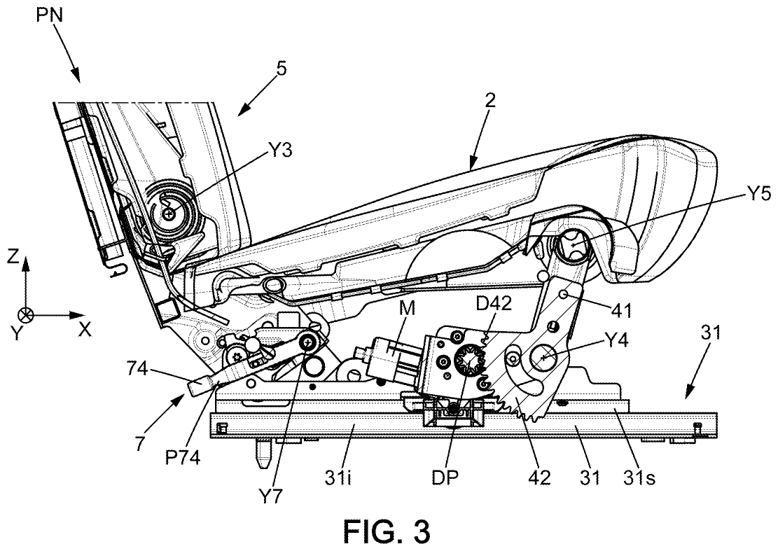

### FIG. 3

FIG. 3 is a sectional view along a plane parallel to the plane XZ, showing on the rear part of the underframe of the seat, on the left, a handle for controlling the first locking means, and on the right, the front connecting rod which comprises a toothed sector at the first end articulated to the anchoring means along the fourth transverse axis, engaged with an output pinion of the electric motor.

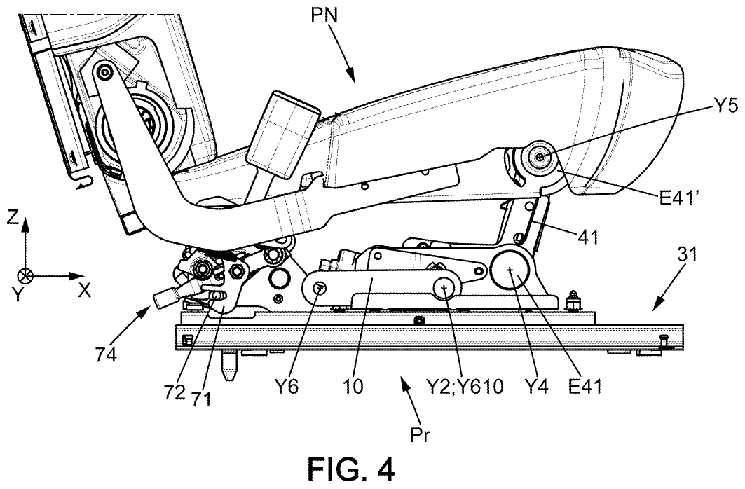

### FIG. 4

FIG. 4 is a sectional view along a plane parallel to the plane XZ, showing on the rear part of the underframe of the seat, on the one hand, on the left, the control handle of the first locking means, as well as a hook rotatably mounted on the underframe which is configured to attach a pin rigidly connected to the anchoring means in the locked state of the first locking means, and which is configured to pivot and escape the pin, during a manual lifting of the control handle, or else under the control of an electric actuator of the first locking means, and on the other hand, showing, in the central part, the emergency connecting rod pressed along the upper profile of the slide forming the anchoring means, in said rest position of the emergency connecting rod.

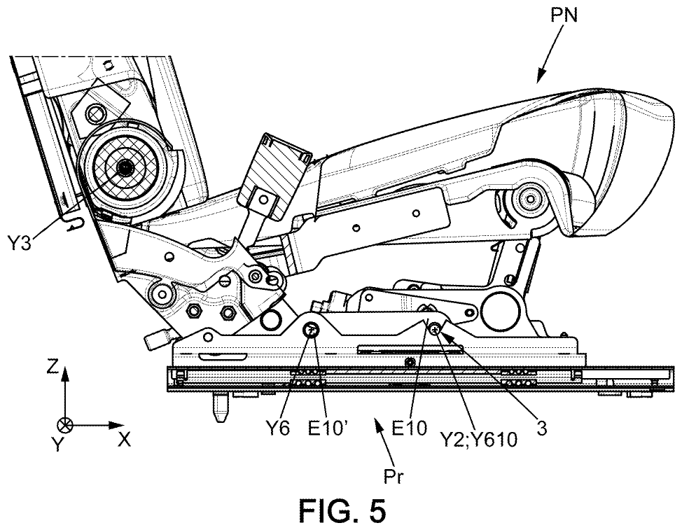

### FIG. 5

FIG. 5 is a view of FIG. 4, along a slightly offset cutting plane, showing more particularly, in the rest position of the emergency connecting rod, the shaft forming a transverse axis of rotation between the connecting rod and the underframe which is supported against a bearing surface of a recess integral with the upper profile of the anchoring means.

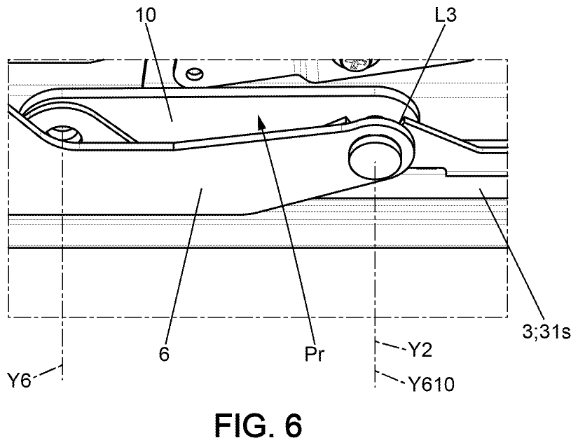

### FIG. 6

FIG. 6 is a view of the seat of FIG. 5, showing the detail and perspective of the emergency connecting rod in the rest position.

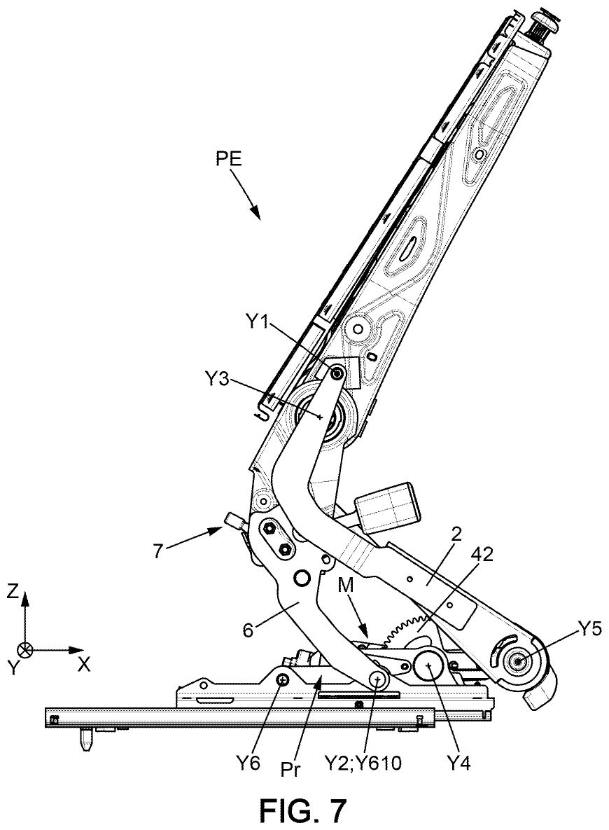

### FIG. 7

FIG. 7 is a view of the seat, in an easy-entry position, obtained from the seat of FIG. 1 in its nominal position after electrical unlocking of the first motorized locking and tilting means toward the front of the assembly formed by the seat frame, the backrest and the underframe around the second transverse axis, by activating the electric motor and rotating the toothed sector relative to the anchoring means about said fourth transverse axis, in a direction of tilting the front connecting rod towards the front of the seat.

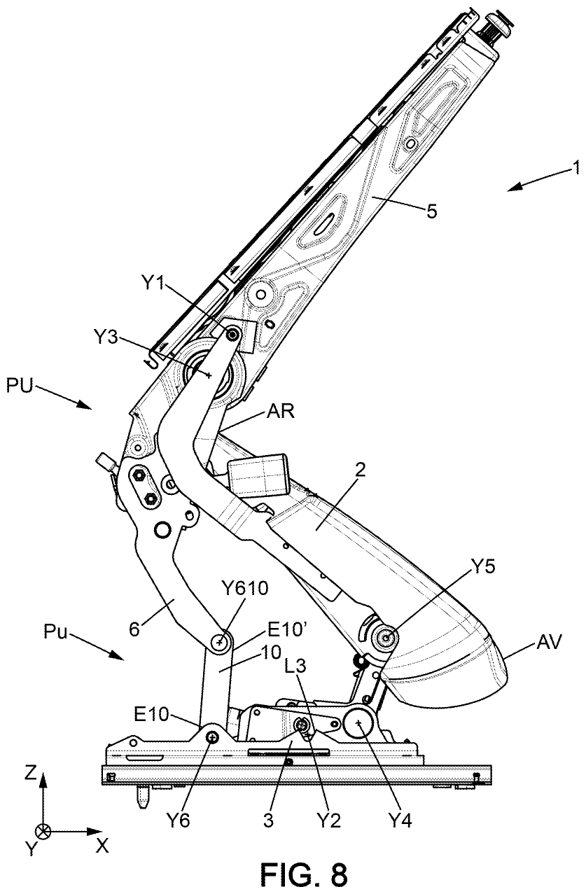

### FIG. 8

FIG. 8 is a view of the seat, in an emergency discharge position, obtained from the seat of FIG. 1 in its nominal position, after manual unlocking of the first unlocking means, and manual tilting forward the assembly formed by the seat frame, the backrest and the underframe around the fifth transverse axis, the front connecting rod being rotationally locked about said fourth transverse axis by the irreversible motor, and by pivoting the emergency connecting rod relative to the anchoring means around the sixth transverse axis, and pivoting the emergency connecting rod relative to the underframe to a position where said articulation pin between the emergency connecting rod and the underframe has escaped the recess of the anchoring means, said pin between the emergency connecting rod and the underframe no longer coinciding with the second transverse axis, positioned in the vertical direction between said second transverse axis and the third transverse axis.

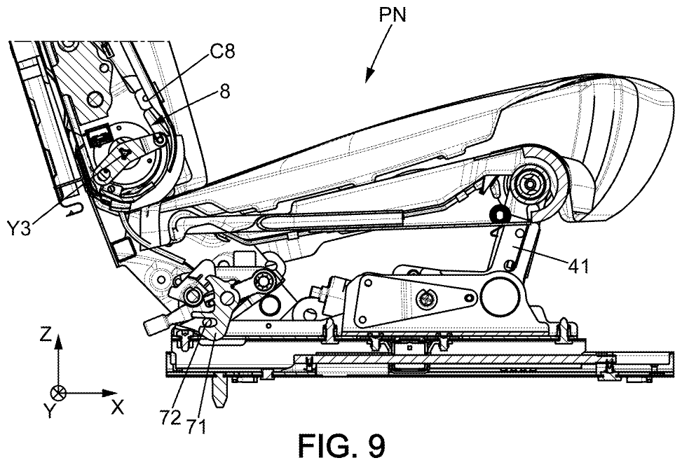

### FIG. 9

FIG. 9 is a sectional view of the seat in its nominal position of FIG. 1, showing the mechanism controlled by a cable allowing the state of the second locking means to change from the locked state to the unlocked state, when an electric actuator pulls on the cable in order to allow the backrest to rotate relative to the underframe around said third transverse axis.

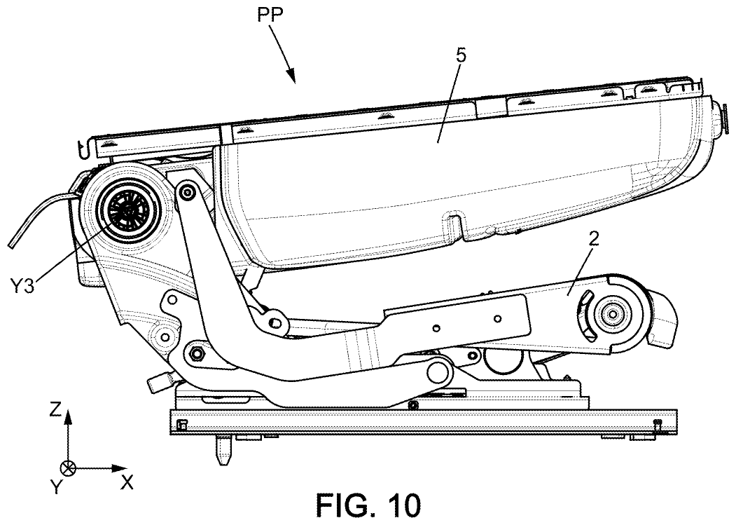

### FIG. 10

FIG. 10 is a subsequent view of FIG. 9, in a flat floor position, obtained from the nominal position, after electrical unlocking of the second locking means, then motorized tilting toward the front of the backrest against a seat base of the seat around the third transverse axis between the backrest and the underframe by activating the electric motor and rotating the toothed sector relative to the anchoring means about said fourth transverse axis, in a direction of tilting the front connecting rod towards the front of the seat.

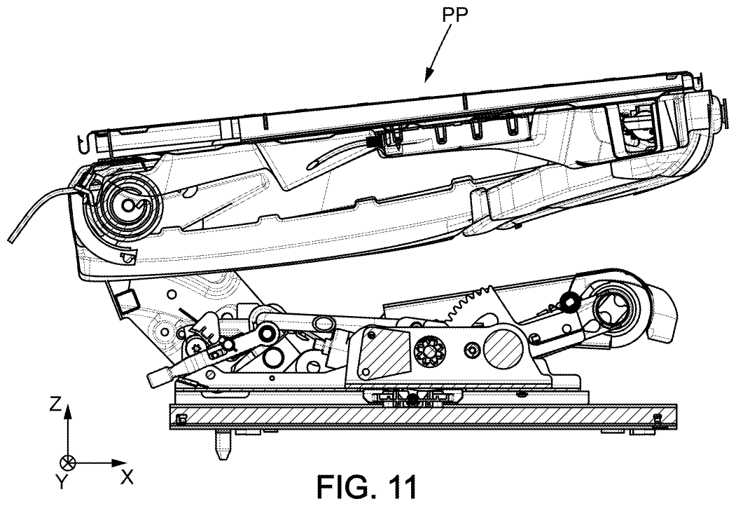

### FIG. 11

FIG. 11 is a sectional view of FIG. 10.

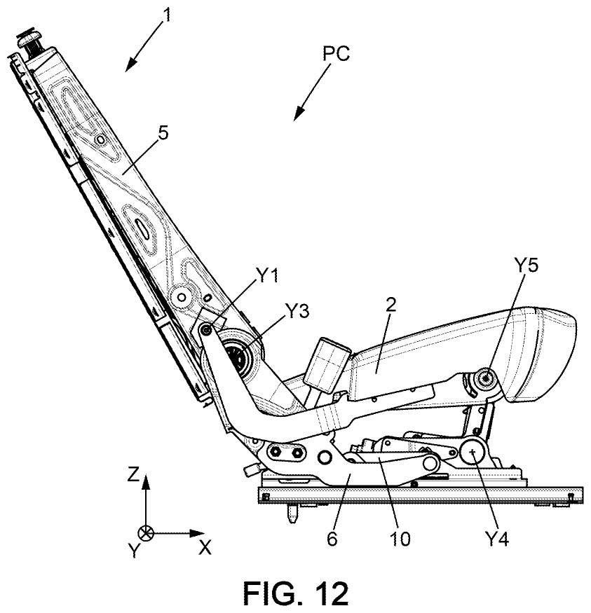

### FIG. 12

FIG. 12 is a subsequent view of FIG. 9, in a comfort position, obtained from the nominal position, after electrical unlocking of the second locking means, then motorized tilting toward the rear of the backrest around the third transverse axis between the backrest and the underframe by activating the electric motor and rotating the toothed sector relative to the anchoring means about said fourth transverse axis, in a direction of tilting the front connecting rod towards the front of the seat.

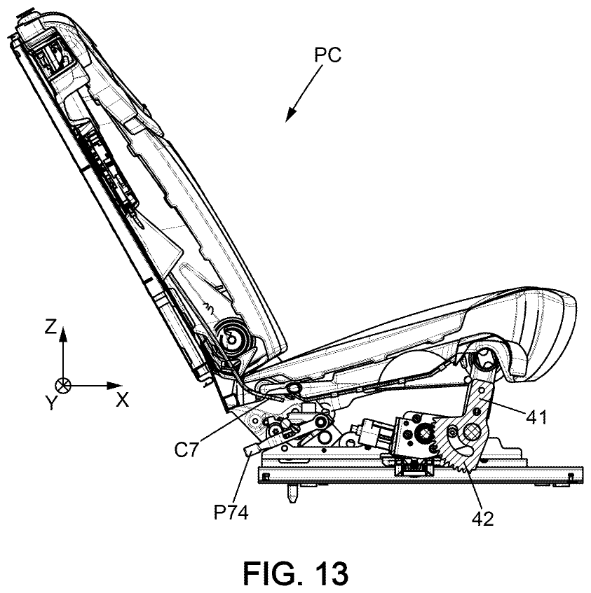

### FIG. 13

FIG. 13 is a sectional view of FIG. 12.

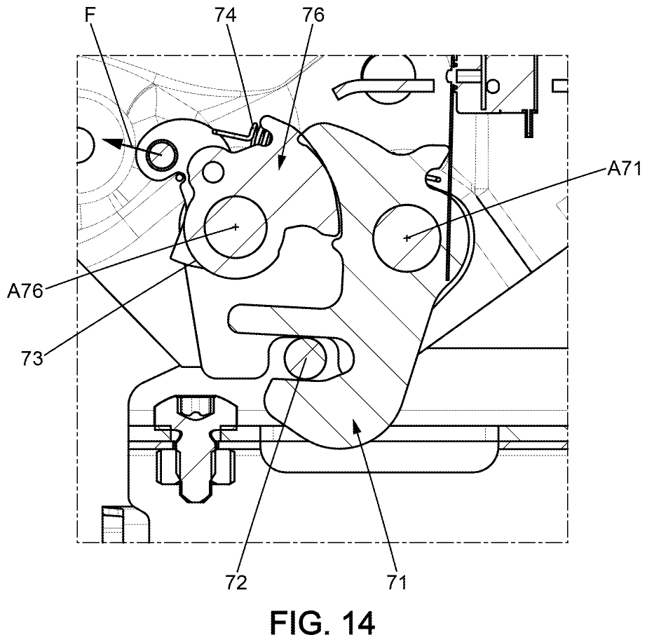

### FIG. 14

FIG. 14 is a cross-section showing in detail the mechanism of the first locking means, including the hook, constrained to lock the pin by a tilter under the action of a first resilient means, in particular a torsion spring, the tilter being able to move into a position where it escapes the hook, which is then free to escape the pin under the action of a second resilient means, in particular an extension spring.

### DESCRIPTION OF THE EMBODIMENTS

The following drawings and description contain, for the most part, elements of certainty. They may therefore not only serve to enhance understanding of this disclosure, but also contribute to its definition, where appropriate.

The invention overcomes the gaps in vehicle seats of the prior art by proposing a single vehicle seat, able to automatically switch, via an irreversible electric motor, between different configurations, and in particular “nominal”, “easy entry”, “flat floor”, or “comfort” positions (or configurations), and wherein the movement of the seat frame/underframe/backrest assembly relative to the floor of the vehicle can be performed manually by a user, in the event of an emergency, with a simplified design and reduced cost.

Throughout the present application, the directions of space are defined as follows:
the longitudinal direction X of the seat corresponds to the direction of sliding of the seat relative to the floor of the vehicle along slides, when the seat comprises slides as anchoring means for anchoring to the floor of the vehicle, received on the seat frame of the seat, as shown in the exemplary embodiments of the figures,
the vertical direction Z of the seat corresponds to the direction perpendicular to the plane of the floor of the vehicle to which the seat is attached, also perpendicular to the longitudinal direction X of the seat defined above, as shown in the exemplary embodiments of the figures,
the transverse direction Y of the seat is the direction perpendicular to the longitudinal direction and to the vertical direction, as shown in the exemplary embodiments of the figures.

Likewise, a seat plane is defined according to the directions of the seat that it contains.

An axis is defined as a straight line in a determined direction. For example, a transverse axis is an axis in said transverse direction.

Additionally, front and rear refer to said longitudinal direction of the seat, with an orientation from the rear edge of the seat frame, at which a backrest is generally articulated toward the front edge of the seat frame.

Likewise, upper (top) and lower (bottom) refer to the vertical direction of the seat, with an orientation from the anchoring means for anchoring to the floor of the vehicle, and in particular the slides, toward the seat frame of the seat.

Finally, throughout the present application, substantially longitudinal, transverse or vertical means refer to an orientation relative to the longitudinal direction, the vertical direction or the transverse direction, with an angle of less than 30°, which may advantageously be zero.

Likewise, substantially parallel refers to an orientation relative to a given element with an angle of less than 30°, which can advantageously be zero.

Thus, the present disclosure relates to a vehicle seat 1 comprising:
a seat frame 2 having a front edge AV and a rear edge AR connected to each other by a first lateral edge BL1 and a second lateral edge BL2,
anchoring means 3 for anchoring the seat 1 to the floor of a vehicle,
connecting means 4 for connecting the seat frame 2 to the anchoring means 3, allowing the seat frame 2 to move relative to the anchoring means 3 at least in the longitudinal direction X and in the vertical direction Z of the seat 1,
a backrest 5 pivotably articulated to the seat frame 2 near its rear edge AR along a first transverse axis Y1 of the seat 1,
an underframe 6 pivotably articulated to the anchoring means 3 along a second transverse axis Y2 of the seat 1 and pivotably articulated to the backrest 5 along a third transverse axis Y3 of the seat 1.

Said connecting means 4 comprise:
a front connecting rod 41 having a first longitudinal end E41 and a second longitudinal end E41′, said front connecting rod 41 being pivotably articulated to the anchoring means 3 near its first longitudinal end E41 along a fourth transverse axis Y4 of the seat 1 and pivotably articulated to the seat frame 2 near its second longitudinal end E41′ along a fifth transverse axis Y5 of the seat 1, near its front edge AV,
a toothed sector 42 pivotably articulated to the anchoring means 3 along said fourth transverse axis Y4 of the seat 1, attached to the first end E41 of the front connecting rod 41.

According to the present disclosure, the seat 1 further comprises an irreversible electric motor M configured for:
driving the rotation of the toothed sector 42 relative to the anchoring means 3 about said fourth transverse axis Y4, when enabled, and
preventing the rotation of the toothed sector 42 relative to the anchoring means 3 about said fourth transverse axis Y4, when disabled.

According to the present disclosure, the seat 1 further comprises:
first locking means 7 able to switch:
   from a locked state, wherein said first locking means 7 prevents the underframe 6 from rotating relative to the seat 1 anchoring means 3 about said second transverse axis Y2, to
   an unlocked state, wherein said first locking means 7 allows a rotation of the underframe 6 relative to the seat 1 anchoring means 3 about said second transverse axis Y2, and vice versa,
a second locking means 8 able to switch:
   from a locked state, wherein said second locking means 8 prevents the backrest 5 from rotating relative to the underframe 6 about said third transverse axis Y3, to
   an unlocked state, wherein said second locking means 8 allows the backrest 5 to rotate relative to the underframe 6 about said third transverse axis Y3, and vice versa.

The seat 1 according to the invention advantageously uses a single irreversible electric motor M to drive the movements of the seat frame 2 and the underframe 6 relative to the anchoring means 3 as well as the backrest 5 relative to the seat frame 2 and relative to the underframe 6, and not one or more reversible motors, as in vehicle seats of the prior art.

An irreversible electric motor provides higher torque than a reversible motor. In particular, as explained above, for a substantially equivalent form factor and power, an irreversible electric motor can supply a motor torque at least twice that of the motor torque supplied by a reversible electric motor. The irreversible electric motor M of the seat according to the invention may for example provide a motor torque greater than or equal to 40 Nm, and preferably greater than or equal to 50 Nm, while the reversible electric motors of the vehicle seats of the prior art generally provide a motor torque of about 25 Nm.

Because of this, the movements of the seat frame 2 and the underframe 6 relative to the anchoring means 3 and the backrest 5 relative to the seat frame 2 and relative to the underframe 6 to move from one configuration of the seat 1 to another are easily driven by said single irreversible electric motor M. There is no need to lighten the elements of the seat 1 and in particular its seat frame 2, its underframe 6 or its backrest 5 so that said electric motor M is able to drive the movements of the seat frame 2 and the underframe 6 relative to the anchoring means 3 and the backrest 5 relative to the seat frame 2 and relative to the underframe 6, despite the reduced lever arm between the two longitudinal ends E41, E41′ of the front connecting rod 41. This makes it possible to simplify the design of the seat 1 according to the invention and to reduce its cost.

In addition, since said electric motor M is irreversible, said electric motor M, when it is disabled, for example when it is not supplied with electricity or when it does not work, for example if it has been damaged, prevents the rotation of the front connecting rod 41 relative to the anchoring means 3 around the fourth transverse axis Y4 at its first longitudinal end E41, and thus makes it possible to retention of the seat frame 2, as well as the backrest 5, in position relative to the anchoring means 3. Unlike vehicle seats of the prior art, the seat 1 according to the invention does not require additional locking means, in particular electrical locking means, to lock the retention of the seat frame 2 relative to the anchoring means 3 after its movement driven by said electric motor M, which also makes it possible to simplify its design and reduce its cost.

Although the use of an irreversible motor M advantageously makes the retention of the seat frame 2, and of the backrest 5, reliable by preventing the front connecting rod 41 from rotating relative to the anchoring means 3, such retention is an obstacle to easily performing the manual tilting of the seat frame and backrest relative to the anchoring means, in particular to allow an emergency evacuation (or emergency exit) of a user located behind the seat.

Notably, to address this problem, and according to the present disclosure, the underframe 6 is articulated to the anchoring means 3 by means of an emergency connecting rod 10, having a first longitudinal end E10 articulated to the anchoring means 3, along a sixth transverse axis Y6 and a second longitudinal end E10′ articulated to the underframe 6 with an articulation pin Y610 between the emergency connecting rod 10 and the underframe 6 which constitutes the second transverse axis Y2 when the emergency connecting rod 10 is in a rest position Pr pressed against the anchoring means 3.

In the rest position of the emergency connecting rod 10, it is noted that the sixth transverse axis Y6 is arranged in the longitudinal direction X between the second transverse axis Y2 and the third transverse axis Y3, and as shown in FIG. 5.

This emergency connecting rod 10 is configured to be in said rest position Pr when the first locking means 7 is in said locked state, as shown in the “nominal position” (or nominal configuration) of the seat as shown in FIG. 1, in the flat floor position PP as shown in FIG. 11, or in the comfort position PC which are described in more detail below.

This emergency connecting rod 10 is further configured to be in said rest position when the front connecting rod 41 is tilted forward by the action of the irreversible motor M to cause the underframe 6 to pivot about the second transverse axis Y2 in the locked state of the second locking means 8, and in particular until the easy entry position PE shown in FIG. 7 is obtained. In such a case, the pivoting along the second transverse axis Y2 is obtained by said articulation pin Y610 between the emergency connecting rod 10 and the underframe 6

Advantageously, and according to the present disclosure, the emergency connecting rod 10 is configured to adopt an emergency position Pu when the first locking means 7 is in the unlocked state, the second locking means 8 being in the locked state and when the front connecting rod is locked in rotation about said fourth transverse axis by the irreversible motor, by pivoting the emergency connecting rod 10 relative to the anchoring means 3 about the sixth transverse axis Y6, and by pivoting the emergency connecting rod 10 relative to the underframe 6 around the articulation pin Y610 between the emergency advantageously connecting rod 10 and the underframe 6 by allowing the seat frame 2 to tilt forwards around the fifth transverse axis Y5, with the assembly formed by the backrest 5 and the underframe 6 being driven forward in the longitudinal direction X and upward in the vertical direction Z by the articulation formed by the first transverse axis Y1 between the backrest 5 and the seat frame 2 to a position where said articulation pin Y610 between the emergency connecting rod 10 and the underframe 6 no longer coincides with the second transverse axis Y2, but rather is positioned in the vertical direction Z between said second transverse axis Y2 and the third transverse axis Y3. The present disclosure also relates to a control method wherein a manual emergency evacuation control is carried out for a user stuck behind a seat according to the present disclosure that is in a nominal position in which the backrest 5 is raised from the seat frame 2, the first locking means 7 are in the locked state, and the second locking means 8 are in the locked state, the emergency connecting rod 10 is in the rest position Pr, the emergency evacuation control being carried out by the following steps:
unlocking, preferably manual, of the first locking means 7,
manual forward tilting of the seat frame 2 about the fifth transverse axis Y5 with the assembly formed by the backrest 5 and the underframe 6 being driven forward in the longitudinal direction X and upward in the vertical direction Z by the articulation formed by the first transverse axis Y1 between the backrest 5 and the seat frame 2 when the front connecting rod 41 is rotationally locked about said fourth transverse axis Y4 by the irreversible motor by pivoting the emergency connecting rod 10 relative to the anchoring means 3 for anchoring around the sixth transverse axis Y6, and pivoting the emergency connecting rod 10 relative to the underframe 6 to a position where said articulation pin Y610 between the emergency connecting rod 10 and the underframe 6 no longer coincides with the second transverse axis Y2, but positioned in the vertical direction Z between said second transverse axis Y2 and the third transverse axis Y3.

During the tilting of the seat frame 2 around the fifth transverse axis Y5, the assembly formed by the backrest 5 and the underframe 6 is driven forward in the longitudinal direction X and upward in the vertical direction Z, with (light) pivoting of the backrest 5 and underframe 6 assembly relative to the seat frame 2 about the first transverse axis Y1.

Such a method for controlling emergency evacuation makes it possible to switch the seat into the emergency position PU, shown in FIG. 8, facilitating access to the seats located behind the seat.

As shown in FIG. 8, the assembly comprising the seat frame 2, the backrest 5 and the underframe 6 is tilted forward, by pivoting the seat frame 2 around said fifth transverse axis Y5, or even (light) pivoting between the seat frame 2 and the backrest 5 and underframe 6 assembly about the first transverse axis Y1, while the front connecting rod 41 is rotationally locked along the fourth transverse axis Y4 by the irreversible motor M.

This tilting of the seat into the emergency position is configured so that, relative to the “nominal” position:
the front edge AV of the seat frame 2 is brought closer to the anchoring means 3 in the vertical direction Z of the seat 1,
the rear edge AR of the seat frame 2 is moved forward, in the longitudinal direction X of the seat 1, and separated from the anchoring means 3 in the vertical direction Z of the seat 1.

Likewise, the underframe 6 can be configured so that its articulation to the backrest 5 along the third transverse axis Y3 is moved forward, in the longitudinal direction X of the seat 1, and separated from the anchoring means 3 in the vertical direction Z of the seat 1.

As can be seen in the exemplary embodiments of FIGS. 1 to 5, in the “nominal” position of the seat, the seat frame 2 can extend substantially in the longitudinal direction X of the seat 1, substantially parallel to the floor of the vehicle receiving the seat 1. A user can thus sit on the seat 1 according to the invention, in particular when the vehicle is moving.

In such a configuration, the front connecting rod 41 can be configured so as to extend substantially in the vertical direction Z of the seat 1, with its second longitudinal end E41′ positioned above its first longitudinal end E41 in the vertical direction Z of the seat 1.

The first 7 and the second 8 locking means are in their locked state.

The seat may, for example, also adopt a so-called “easy entry” position, similar to that described above in the introduction of the present application, and shown in the embodiment of FIG. 7.

As explained above, such a configuration makes it possible to free the passage at the rear of the seat, for example to allow users to enter or exit the vehicle receiving the seat 1, passing through the rear of said seat 1, in particular when it is a vehicle without rear doors.

In such a configuration, the seat frame 2 and the underframe 6 are moved relative to the anchoring means 3 in the longitudinal direction X and in the vertical direction Z of the seat 1, relative to the “nominal” configuration.

The connecting means 4 can thus be configured so that, relative to the “nominal” position:
the front edge AV of the seat frame 2 is moved forward, in the longitudinal direction X of the seat 1, and brought closer to the anchoring means 3 in the vertical direction Z of the seat 1,
the rear edge AR of the seat frame 2 is moved forward, in the longitudinal direction X of the seat 1, and separated from the anchoring means 3 in the vertical direction Z of the seat 1.

Likewise, the underframe 6 can be configured so that its articulation to the backrest 5 along the third transverse axis Y3 is moved forward, in the longitudinal direction X of the seat 1, and separated from the anchoring means 3 in the vertical direction Z of the seat 1.

In such a configuration, the front connecting rod 41 can be configured so as to be inclined towards the front of the seat 1, i.e. its second longitudinal end E41′ is located in front of its first longitudinal end E41 in the longitudinal direction X of the seat 1.

The first locking means 7 is in its unlocked state while the second locking means 8 is in its locked state.

The switch from the “nominal” configuration to the “easy entry” configuration, or vice versa, is done via the electric motor M, while it is enabled, which rotates the toothed sector 42 and therefore the front connecting rod 41 relative to the anchoring means 3 around the fourth transverse axis Y4 of the seat 1 at its first longitudinal end E41, the second locking means 8 being in its unlocked state, while the first locking means 7 is in its locked state. Thus, thanks to the simultaneous action of the seat frame 2 on the backrest 5 by means of their articulation along the first transverse axis Y1 and of the backrest 5 on the underframe 6 by means of their articulation along the third transverse axis Y3, the rotation of the front connecting rod 41 about the fourth transverse axis Y4 simultaneously causes the seat frame 2 to move relative to the anchoring means 3 and the underframe 6 to pivot relative to the anchoring means 3 about said second transverse axis Y2, and in particular by virtue of the high torque delivered by the irreversible electric motor M. Once the electric motor M is stopped, the seat frame 2 is blocked in the desired configuration, the electric motor M being irreversible.

Thus, the present disclosure further relates to a control method wherein a motorized control for easy entry facilitating access to the seats behind a seat according to the present disclosure is then carried out in a nominal position PN of the seat for which the backrest 5 is raised from the seat frame 2, with the first locking means 7 in the locked state and the second locking means 8 in the locked state, and the emergency connecting rod 10 in the rest position Pr, the motorized control for easy entry being implemented by the following steps:
unlocking the first locking means 7,
motorized forward tilting of the assembly formed by the backrest 5 and the underframe 6 about the second transverse axis Y2 by activating the electric motor M and rotating the toothed sector 42 relative to the anchoring means 3 about said fourth transverse axis Y4, in a direction of tilting the front connecting rod 41 towards the front of the seat.

During such a tilting, the seat frame 2 is caused to pivot slightly relative to the backrest 5 about the first transverse axis Y1.

The seat 1 may for example also adopt a so-called “flat floor” configuration, similar to that described above in the present application, and shown in the exemplary embodiments of FIGS. 10 and 11.

As can be seen in the exemplary embodiments of FIGS. 10 and 11, in this “flat floor” configuration, the backrest 5 can be folded back against the seat frame 2, or more precisely against a seat trim secured to the seat frame by extending substantially parallel thereto and the seat frame 2 may also extend substantially in the longitudinal direction X of the seat 1, substantially parallel to the floor of the vehicle receiving the seat 1 by having been moved forward in the longitudinal direction X of the seat 1 and downward in the vertical direction Z of the seat 1 relative to its position in said “nominal” configuration. Such a “flat floor” configuration advantageously makes it possible to reduce the form factor of the seat in its vertical direction, and for example in order to be able to deposit one or more loads onto the backrest 5 folded against the seat frame 2, in particular when said seat is located behind a vehicle just in front of a rear loading compartment of the vehicle, in the longitudinal direction of the vehicle.

The first locking means 7 is in the locked state while the second locking means 8 is in the unlocked state.

The switch from the “nominal” configuration to the “flat floor” configuration, or vice versa, is done via the electric motor M, while it is enabled, which rotates the toothed sector 42 and therefore the front connecting rod 41 relative to the anchoring means 3 around the fourth transverse axis Y4 of the seat 1 at its first longitudinal end E41. Additionally, the second locking means 8 is in its unlocked state, while the first locking means 7 is in its locked state. Thus, thanks to the action of the seat frame 2 on the backrest 5 by means of their articulation along the first transverse axis Y1, the rotation of the front connecting rod 41 around the fourth transverse axis Y4 simultaneously causes the seat frame 2 to move relative to the anchoring means 3 and backrest 5 to pivot relative to the seat frame 2 about said first transverse axis Y1 and relative to the underframe 6 about said third transverse axis Y3 so as to bring the backrest 5 closer to the seat frame 2, and in particular due to the high torque delivered by the irreversible electric motor M. Once the electric motor M is stopped, the seat frame 2 is blocked in the desired configuration, the electric motor M being irreversible.

Thus, the present disclosure further relates to a control method wherein a motorized flat-floor control of a seat according to the present disclosure is then carried out in a nominal position PN of the seat for which the backrest 5 is raised from the seat frame, with the first locking means 7 in the locked state and the second locking means 8 in the locked state, the emergency connecting rod 10 in the rest position, the motorized flat-floor control being implemented by the following steps:
unlocking the second locking means 8,
motorized forward tilting of the backrest 5 against a seat base of the seat about the third transverse axis Y3 between the backrest 5 and the underframe 6 by activating the electric motor M and rotating the toothed sector 42 relative to the anchoring means 3 about said fourth transverse axis Y4, in a direction of tilting the front connecting rod 41 towards the front of the seat.

In order for the electric motor M to rotate the toothed sector 42 relative to the anchoring means 3 about the fourth transverse axis Y4, the pinion 42 may comprise a plurality of teeth D42, configured to mesh with the teeth DP of a toothed gear rotated by means of said electric motor M.

The anchoring means 3 may have at least one slide 31 comprising a lower profile 31i rigidly connected to the floor and an upper profile 31s, mounted slidably relative to one another in the longitudinal direction X, said upper profile 31s carrying the second transverse axis Y2, the fourth transverse axis Y4 and the sixth transverse axis Y6.

The anchoring means 3 may for example comprise two slides 31, arranged on either side of the seat frame 2 in the transverse direction Y of the seat 1, configured so as to allow the seat 1 to move in translation relative to the floor of the vehicle receiving the seat 1 in the longitudinal direction X of the seat 1.

Said slides 31 can each have a lower profile 31i configured to be fixed to the floor of the vehicle, and slidably receiving, in the longitudinal direction X of the seat 1, an upper profile 31s.

Advantageously, the first longitudinal end E41 of the front connecting

rod 41 and/or the underframe 6 can be pivotally articulated to the upper profile 31s of a slide 31, respectively along said fourth transverse axis Y4 and along said second transverse axis Y2 of the seat 1, as well as the emergency connecting rod 10 along the sixth transverse axis Y6. The slides 31 can be motorized slides.

As shown in FIGS. 5 and 6, the articulation pin Y610 between the emergency connecting rod 10 and the underframe 6 may comprise a shaft connecting the emergency connecting rod 10 and the underframe 6.

Advantageously and as shown in FIG. 5, said shaft can be configured to come to bear in the rest position Pr of the emergency connecting rod 10 against a recess L3 integral with the anchoring means 3, the recess L3 constituting a span for the shaft in said rest position Pr of the emergency connecting rod. This arrangement allows a direct transmission of the load from the underframe 6 to the anchoring means 3 by the shaft, by relieving the emergency connecting rod 10 that is then in the rest position.

As can be seen in FIG. 8 in the emergency position of the emergency connecting rod, the shaft forming the articulation pin Y610 between the emergency connecting rod 10 and the underframe 6 is configured to escape from the recess L3.

The first locking means 7 may further comprise a first manual control means 74 configured to drive the switching of the first locking means 7 from its locked state to its unlocked state and vice versa by a manual action of a user on said first manual control means 74. Said first manual control means 74 may comprise a handle P74 pivotably mounted relative to the underframe 6 about a seventh transverse axis Y7 of the seat 1, accessible by a user from the rear of the seat.

FIG. 3 is a sectional view showing the handle P74 that can be grasped by the operator. The unlocking command is preferably given by raising this handle.

The first locking means 7 may comprise a hook 71, rotating about a transverse axis A71, and engaging a pin 72 of the anchoring means in the locked state, in particular attached to the upper profile 31s of the slide. The first locking means 7 in particular comprise, for each of the two slides, a hook-and-bolt pair 71 rotatably mounted relative to the underframe 6, and a pin 72 secured to the upper profile of the slide.

The switching of the first locking means 7 to the unlocked state is carried out by a command ensuring the pivoting of the hooks until the pin 72 is released. FIG. 14 gives an example mechanism.

It will be noted that the hook 71 is constrained in engagement with the pin 72 by a tilter 76, pivotably articulated about the transverse axis A76. To this end, the tilter 76 is equipped with a torsion spring 73 that forces the tilter.

During an emergency evacuation command, in particular during the lifting of the handle P74, a transmission makes it possible to pivot the tilter 76, in the counterclockwise direction by exerting a force F shown in FIG. 14 and so as to release the rotation of the hook 71. The hook 71 then pivots counterclockwise under the action of an extension spring 74, until the pin 72 is released.

According to one embodiment, the first locking means 7 may comprise an actuator AT, and in particular an electric motor, configured to drive the automatic switching of the first locking means 7 from its locked state to its unlocked state, and vice versa.

In particular, the actuator AT, in particular the electric motor can be located in the backrest 5, and comprise a cable transmission C7 to allow the switching of the first locking means 7 to its unlocked state. In particular in FIG. 13, it will be noted that this cable C7 is attached to the control handle P74. In such a case, the automatic unlocking is carried out by controlling the actuator AT which pulls on the cable, by causing the automatic lifting of the control handle P74, and in particular the detachment of the two hooks 71 of the pins 72. To allow locking again, the actuator exerts a reverse movement on the cable

According to one embodiment, the second locking means 8 comprises an actuator AT, and in particular an electric motor, configured to drive the automatic switching of the second locking means 8 from its locked state to its unlocked state, and vice versa. This is an electric motor with a cable C8 transmission to the locking mechanism integrated at the third transverse axis Y3 of the seat, and as seen in FIG. 9.

The actuator of the first locking means 7 may advantageously be the actuator of the second locking means 8. In particular, the actuator AT, is configured to unlock the first locking means or the second locking means, by pulling on either of the two cables C7 and C8, or else to leave the first and second locking means 7, 8 both in their locked state.

### LIST OF REFERENCE SIGNS

1. Seat
X. Longitudinal direction
Y. Transverse direction
Z. Vertical direction
Y1, Y2, Y3, Y4, Y5, Y6, Y7. Transverse axes
2. Lower frame
AV. Front edge
AR. Rear edge
BL1, BL2. Side edge
3. Anchoring means
31. Slide
31i. Lower profile
31s. Upper profile
4. Connection means
41. Front connecting rod
E41. First longitudinal end
E41′ Second longitudinal end
42. Toothed sector
D42. Teeth
M. Electric motor
DP. Pinion teeth
5. Backrest
6. Underframe
7. First locking means
71. Hook
72. Pin
73. Torsion spring,
74. First manual control means
74 Extended spring,
76. Tilter,
A71, A76 transverse articulation pins (respectively for the hook and the tilter)
8. Second locking means
P74. Handle,
10. Emergency connecting rod,
AT. Actuator,
C7, C8. Cable (for first and second locking means, respectively),
E10 First end (emergency connecting rod to the anchoring means 3),
E10′ Second end (emergency connecting rod to the underframe),
Y610. An articulation pin between the emergency connecting rod and the underframe,
Pr, Pu. Rest and emergency positions
L3. Recess for anchoring means forming a span for the shaft forming the pin
Y610. A transverse axis of rotation between the emergency connecting rod and the underframe
PN Nominal position of the seat,
PU Emergency position of the seat,
PE Easy entry position of the seat,
PP Flat floor position of the seat,
PC. Comfort position.

1-11. (canceled)

12. A vehicle seat comprising:
a seat frame having a front edge and a rear edge connected to each other by a first lateral edge and a second lateral edge,
anchoring means for anchoring the seat to the floor of a vehicle,
connecting means for connecting the seat frame to the anchoring means, allowing the seat frame to move relative to the anchoring means at least in the longitudinal direction and in the vertical direction of the seat,
a backrest pivotably articulated to the seat frame near its rear edge along a first transverse axis of the seat,
an underframe pivotably articulated to the anchoring means along a second transverse axis of the seat and pivotably articulated to the backrest along a third transverse axis of the seat,
wherein said connecting means comprise:
a front connecting rod having a first longitudinal end and a second longitudinal end, said front connecting rod being pivotably articulated to the anchoring means near its first longitudinal end along a fourth transverse axis of the seat and pivotably articulated to the seat frame near its second longitudinal end along a fifth transverse axis of the seat, near its front edge,
a toothed sector pivotably articulated to the anchoring means along said fourth transverse axis of the seat, attached to the first end of the front connecting rod,
wherein the seat further comprises an irreversible electric motor configured to:
drive rotation of the toothed sector relative to the anchoring means about said fourth transverse axis, when enabled, and
blocking rotation of the toothed sector relative to the anchoring means about said fourth transverse axis, when disabled,
and wherein the seat further includes:
first locking means able to switch:
from a locked state, wherein said first locking means blocks the underframe from rotating relative to the seat anchoring means about said second transverse axis, to
an unlocked state, wherein said first locking means allows a rotation of the underframe relative to the seat anchoring means about said second transverse axis, and vice versa,
a second locking means able to switch:
from a locked state, wherein said second locking means blocks the backrest from rotating relative to the underframe about said third transverse axis, to
an unlocked state, wherein said second locking means allows the backrest to rotate relative to the underframe about said third transverse axis, and vice versa, and
wherein the underframe is articulated to the anchoring means by means of an emergency connecting rod having a first longitudinal end articulated to the anchoring means according to a sixth transverse axis and a second longitudinal end articulated to the underframe with an articulation pin between the emergency connecting rod and the underframe which constitutes the second transverse axis when the emergency connecting rod is in a rest position pressed against the anchoring means, in a position for which the sixth transverse axis is arranged in the longitudinal direction between the second and the third transverse axis,
and wherein said emergency connecting rod is configured to be in said rest position in the following cases:
when the first locking means is in said locked state, or
when the front connecting rod is tilted towards the front by the action of the irreversible electric motor, in order to cause the underframe to pivot about the second transverse axis in the locked state of the second locking means and in the unlocked state of the first locking means, and wherein the emergency connecting rod is configured to take an emergency position when the first locking means is in the unlocked state, the second locking means being in the locked state and when the front connecting rod is blocked in rotation about said fourth transverse axis by the irreversible motor, by pivoting the emergency connecting rod in relation to the anchoring means about the sixth transverse axis, and by pivoting the emergency connecting rod in relation to the underframe about the articulation axis between the emergency connecting rod and the underframe, allowing the seat frame to tilt forward about the fifth transverse axis, with the assembly formed by the backrest and the underframe being driven forwards in the longitudinal direction and upwards in the vertical direction by the articulation formed by the first transverse axis between the backrest and the seat frame up to a position where said articulation axis between the emergency connecting rod and the underframe is no longer coincident with the second transverse axis, but rather positioned in the vertical direction between said second transverse axis and the third transverse axis.

13. The vehicle seat of claim 12, wherein the first locking means further comprise a first manual control means configured to drive the passage of the first locking means from its locked state to its unlocked state and vice versa by a manual action of a user on said first manual control means.

14. The vehicle seat of claim 13, wherein said first manual control means comprises a handle pivotably mounted relative to the underframe about a seventh transverse axis of the seat, accessible by a user from the rear of the seat.

15. The vehicle seat of claim 12, wherein the first locking means comprises an actuator, and in particular an electric motor, configured to drive the automatic switching of the first locking means from its locked state to its unlocked state, and vice versa.

16. The vehicle seat of claim 12, wherein the second locking means comprises an actuator, and in particular an electric motor, configured to drive the automatic switching of the second locking means from its locked state to its unlocked state, and vice versa.

17. The vehicle seat of claim 15, wherein the actuator of the first locking means is the actuator of the second locking means.

18. The vehicle seat of claim 12, wherein the articulation pin between the emergency connecting rod and the underframe comprise a shaft pivotably connecting the emergency connecting rod and the underframe, said shaft being configured to bear in the rest position of the emergency connecting rod against a recess, integral with the anchoring means, the recess constituting a span for the shaft in said rest position of the emergency connecting rod, and wherein in the emergency position of the emergency connecting rod, the shaft forming the articulation pin between the emergency connecting rod and the underframe is configured to exit and escape from the recess.

19. The vehicle seat of claim 12, wherein the anchoring means have at least one slide comprising a lower profile rigidly connected to the floor and an upper profile, mounted slidably relative to one another in the longitudinal direction, said upper profile carrying the second transverse axis, the fourth transverse axis and the sixth transverse axis.

20. A control method wherein a manual control of emergency discharge of a user is carried out at the rear of a seat according to claim 12, then in a nominal position of the seat for which the backrest is raised from the seat frame, the first locking means in the locked state and the second locking means in the locked state, the emergency connecting rod in the rest position, the emergency discharge command being implemented by the following steps:
unlocking the first locking means,
manual forward tilting of the seat frame about the fifth transverse axis with the assembly formed by the backrest and the underframe being driven forward in the longitudinal direction and upward in the vertical direction by the articulation formed by the first transverse axis between the backrest and the seat frame when the front connecting rod is rotationally locked about said fourth transverse axis by the irreversible motor by pivoting the emergency connecting rod relative to the anchoring means for anchoring around the sixth transverse axis, and pivoting the emergency connecting rod relative to the underframe to a position where said articulation pin between the emergency connecting rod and the underframe no longer coincides with the second transverse axis, but positioned in the vertical direction between said second transverse axis and the third transverse axis.

21. A control method wherein a motorized control for easy entry facilitating access to the seats behind a seat according to claim 12 is then carried out in a nominal position of the seat for which the backrest is raised from the seat frame, with the first locking means in the locked state and the second locking means in the locked state, and the emergency connecting rod in the rest position, the motorized control for easy entry being implemented by the following steps:
unlocking the first locking means,
motorized forward tilting of the assembly formed by the backrest and the underframe about the second transverse axis by activating the irreversible electric motor and rotating the toothed sector relative to the anchoring means about said fourth transverse axis, in a direction of tilting the front connecting rod towards the front of the seat.

22. A control method wherein a motorized control for flat floor facilitating access to the seats behind a seat according to claim 1 is then carried out in a nominal position of the seat for which the backrest is raised from the seat frame, with the first locking means in the locked state and the second locking means in the locked state, and the emergency connecting rod in the rest position, the motorized control for flat floor being implemented by the following steps:
unlocking the second locking means,
motorized forward tilting of the backrest against a seat base of the seat about the third transverse axis between the backrest and the underframe by activating the irreversible electric motor and rotating the toothed sector relative to the anchoring means about said fourth transverse axis, in a direction of tilting the front connecting rod towards the front of the seat.
